(19) United States
(12) Patent Application Publication
(10) Pub. No.: US 2015/0062291 A1
(43) Pub. Date: Mar. 5, 2015

(54) MOBILE TERMINAL AND CONTROL METHOD THEROF

(71) Applicant: LG ELECTRONICS INC., Seoul (KR)

(72) Inventors: Uijin KIM, Seoul (KR); Seongsu KIM, Seoul (KR); Younghee KANG, Seoul (KR); Sunghwan SHIN, Seoul (KR)

(21) Appl. No.: 14/477,603

(22) Filed: Sep. 4, 2014

(30) Foreign Application Priority Data
Sep. 5, 2013 (KR) 10-2013-0106698

(51) Int. Cl. H04N 5/232

(52) U.S. Cl. CPC H04N 5/23229; H04N 5/23238; H04N 5/23293
USPC 348/36; 348/231.6

(57) ABSTRACT

A mobile terminal including a display; a wireless communication unit configured to provide wireless communication; a camera; and a controller configured to capture an image via the camera; store, in a memory, related capturing information related to the capturing of the image; obtain, through the wireless communication unit, at least one surrounding image related to the captured image based on the related capturing information; and display a synthesized image including the captured image and the obtained at least one surrounding image.

### CROSS-REFERENCE TO RELATED APPLICATIONS

Pursuant to 35 U.S.C. §119(a), this application claims the benefit of earlier filing date and right of priority to Korean Patent Application No. 10-2013-0106698, filed on Sep. 5, 2013, the contents of which are incorporated by reference herein in their entirety.

### BACKGROUND OF THE INVENTION

1. Field of the Invention

The present invention relates to a mobile terminal, and more particularly, a mobile terminal configured to display an image obtained by combining a captured image with an acquired surrounding image to enable a user to view the image more conveniently and a method for controlling the same.

2. Discussion of the Related Art

As functions of terminals such as personal computers, laptop computers, cellular phones diversify, the terminals function as multimedia players having multiple functions for capturing pictures or moving images, playing music, moving image files and games and receiving broadcasting programs.

Terminals can be categorized as mobile terminals and stationary terminals. The mobile terminals can be further comprised of handheld terminals and vehicle mount terminals according to whether users can personally carry the terminals. Terminals including mobile terminals provide an increasing number of complex and various functions.

However, with the increase in the complexity of functions available on the terminal, the user interface is complicated and sometimes difficult for the user to use.

### SUMMARY OF THE INVENTION

Accordingly, one object of the present invention is to provide a mobile terminal configured to display an image obtained by combining a captured image with an acquired surrounding image to enable a user to view the image more conveniently and a method for controlling the same.

To achieve these and other advantages and in accordance with the purpose of the present invention, as embodied and broadly described herein, the present invention provides in one aspect a mobile terminal including a display; a wireless communication unit configured to provide wireless communication; a camera; and a controller configured to capture an image via the camera; store, in a memory, related capturing information related to the capturing of the image; obtain, through the wireless communication unit, at least one surrounding image related to the captured image based on the related capturing information; and display a synthesized image including the captured image and the obtained at least one surrounding image.

In another aspect, the present invention provides a method of controlling a mobile terminal, and which includes capturing, via a camera of the mobile terminal, an image; storing, in a memory, related capturing information related to the capturing of the image; obtaining, via a controller controlling a wireless communication unit of the mobile terminal, at least one surrounding image related to the captured image based on the related capturing information; and displaying, via a display unit of the mobile terminal, a synthesized image including the captured image and the obtained at least one surrounding image.

Further scope of applicability of the present invention will become apparent from the detailed description given hereinafter. However, it should be understood that the detailed description and specific examples, while indicating preferred embodiments of the invention, are given by illustration only, since various changes and modifications within the spirit and scope of the invention will become apparent to those skilled in the art from this detailed description.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention.

FIG. 1 is a block diagram of a mobile terminal according to an embodiment of the present invention;

FIG. 2A is a front perspective view of the mobile terminal according to an embodiment of the present invention;

FIG. 2B is a rear perspective view of the mobile terminal according to an embodiment of the present invention;

FIG. 3 is a view illustrating a proximity depth of a proximity sensor;

FIG. 4 is a flowchart illustrating an image capture operation of a mobile terminal according to an embodiment of the present invention;

FIGS. 5 to 7 are views illustrating the image capture operation of the mobile terminal shown in FIG. 4;

FIG. 8 is a flowchart illustrating an image capture operation of the mobile terminal according to an embodiment of the present invention;

FIG. 9 is a signal flow graph illustrating the operation of the mobile terminal shown in FIG. 8;

FIGS. 10 to 13 are overviews illustrating an image display procedure of the mobile terminal shown in FIG. 8;

FIGS. 14 to 16 are overviews illustrating another image display procedure of the mobile terminal shown in FIG. 8;

FIGS. 17 to 22 are overviews illustrating an operation of the mobile terminal shown in FIG. 8;

FIGS. 23 and 24 illustrate a gallery display method of the mobile terminal shown in FIG. 8;

FIGS. 25 to 27 are overviews illustrating another gallery display method of the mobile terminal shown in FIG. 8;

FIGS. 28 to 31 are overviews illustrating another gallery display method of the mobile terminal shown in FIG. 8; and

FIG. 32 an overview illustrating information acquisition operation of the mobile terminal shown in FIG. 8.

### DETAILED DESCRIPTION

Arrangements and embodiments will now be described more fully with reference to the accompanying drawings. Embodiments may, however, be embodied in many different forms and should not be construed as being limited to embodiments set forth herein; rather, embodiments may be provided so that this invention will be thorough and complete, and will fully convey the concept to those skilled in the art.

A mobile terminal may be described below with reference to the accompanying drawings. In the following description, suffixes “module” and “unit” may be given to components of the mobile terminal in consideration of only facilitation of description and do not have meanings or functions discriminated from each other.

The mobile terminal may include a cellular phone, a smart phone, a laptop computer, a digital broadcasting terminal, personal digital assistants (PDA), a portable multimedia player (PMP), a navigation system and/or so on.

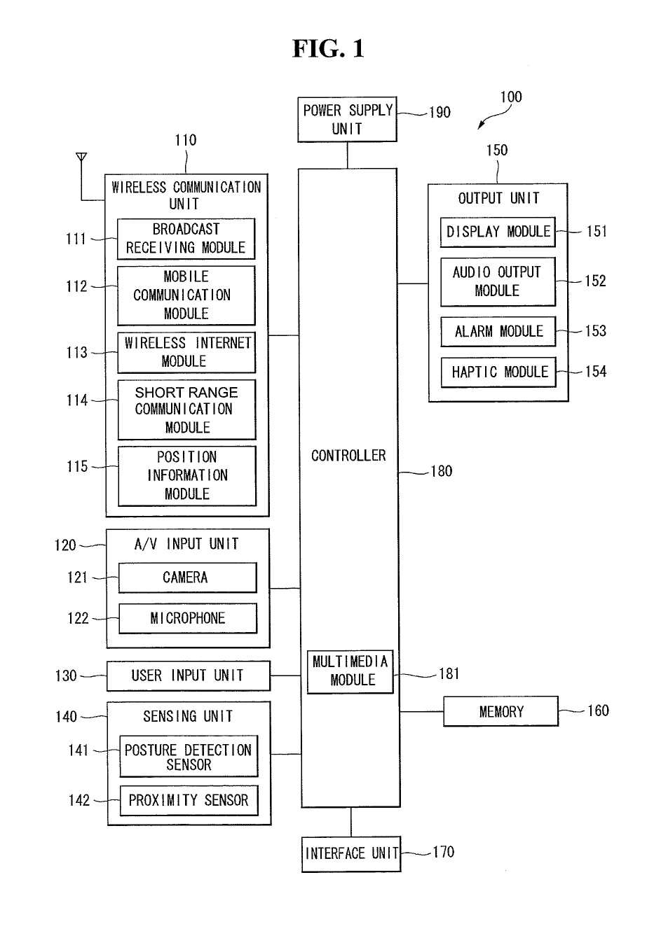

FIG. 1 is a block diagram of a mobile terminal 100 according to an embodiment of the present invention. Other embodiments, configurations and arrangements may also be provided.

As shown, the mobile terminal 100 may include a wireless communication unit 110 (or radio communication unit), an audio/video (A/V) input unit 120, a user input unit 130, a sensing unit 140, an output unit 150, a memory 160, an interface 170, a controller 180, and a power supply 190. The components shown in FIG. 1 may be essential parts and/or a number of components included in the mobile terminal 100 may vary. Components of the mobile terminal 100 will now be described.

The wireless communication unit 110 may include at least one module that enables radio communication between the mobile terminal 100 and a radio communication system or between the mobile terminal 100 and a network in which the mobile terminal 100 is located. For example, the wireless communication unit 110 may include a broadcasting receiving module 111, a mobile communication module 112, a wireless Internet module 113, a short range communication module 114 (or local area communication module), and a location information module 115 (or position information module).

The broadcasting receiving module 111 can receive broadcasting signals and/or broadcasting related information from an external broadcasting management server through a broadcasting channel. The broadcasting channel may include a satellite channel and a terrestrial channel, and the broadcasting management server may be a server that generates and transmits broadcasting signals and/or broadcasting related information or a server that receives previously created broadcasting signals and/or broadcasting related information and transmits the broadcasting signals and/or broadcasting related information to a terminal.

The broadcasting signals may include not only TV broadcasting signals, radio broadcasting signals, and data broadcasting signals but also signals in the form of a combination of a TV broadcasting signal and a radio broadcasting signal. The broadcasting related information may be information on a broadcasting channel, a broadcasting program or a broadcasting service provider, and may be provided even through a mobile communication network. In the latter case, the broadcasting related information may be received by the mobile communication module 112.

The broadcasting related information may exist in various forms. For example, the broadcasting related information may exist in the form of an electronic program guide (EPG) of a digital multimedia broadcasting (DMB) system or in the form of an electronic service guide (ESG) of a digital video broadcast-handheld (DVB-H) system.

The broadcasting receiving module 111 can receive broadcasting signals using various broadcasting systems. More particularly, the broadcasting receiving module 111 can receive digital broadcasting signals using digital broadcasting systems such as a digital multimedia broadcasting-terrestrial (DMB-T) system, a digital multimedia broadcasting-satellite (DMB-S) system, a media forward link only (MediaFLO) system, a DVB-H and integrated services digital broadcast-terrestrial (ISDB-T) systems. The broadcasting receiving module 111 can receive signals from broadcasting systems providing broadcasting signals other than the above-described digital broadcasting systems.

The broadcasting signals and/or broadcasting related information received through the broadcasting receiving module 111 may be stored in the memory 160. The mobile communication module 112 may transmit/receive a radio signal to/from at least one of a base station, an external terminal and a server on a mobile communication network. The radio signal may include a voice call signal, a video telephony call signal or data in various forms according to transmission and reception of text/multimedia messages.

The wireless Internet module 113 corresponds to a module for wireless Internet access and may be included in the mobile terminal 100 or may be externally attached to the mobile terminal 100. Wireless LAN (WLAN or Wi-Fi), wireless broadband (Wibro), world interoperability for microwave access (Wimax), high speed downlink packet access (HSDPA) and so on may be used as a wireless Internet technique.

The short range communication module 114 corresponds to a module for short range communication. Further, Bluetooth®, radio frequency identification (RFID), infrared data association (IrDA), ultra wideband (UWB) and/or ZigBee® may be used as a short range communication technique.

The location information module 115 can confirm or obtain a location or a position of the mobile terminal 100. The location information module 115 may obtain position information by using a global navigation satellite system (GNSS). The GNSS is a terminology describing a radio navigation satellite system that revolves around the earth and transmits reference signals to predetermined types of radio navigation receivers such that the radio navigation receivers can determine their positions on the earth's surface or near the earth's surface. The GNSS may include a global positioning system (GPS) of the United States, Galileo of Europe, a global orbiting navigational satellite system (GLONASS) of Russia, COMPASS of China, and a quasi-zenith satellite system (QZSS) of Japan, for example.

A global positioning system (GPS) module is a representative example of the location information module 115. The GPS module may calculate information on distances between one point or object and at least three satellites and information on a time when distance information is measured and apply trigonometry to the obtained distance information to obtain three-dimensional position information on the point or object according to latitude, longitude and altitude at a predetermined time.

A method of calculating position and time information using three satellites and correcting the calculated position and time information using another satellite may also be used. Additionally, the GPS module can continuously calculate a current position in real time and calculate velocity information using the location or position information.

The A/V input unit 120 can input (or receive) an audio signal and/or a video signal. The A/V input unit 120 may include a camera 121 and a microphone 122. The camera 121 can process image frames of still images or moving images obtained by an image sensor in a video telephony mode or a photographing mode. The processed image frames can be displayed on a display module 151, which may be a touch screen.

The image frames processed by the camera 121 may be stored in the memory 160 or may be transmitted to an external device through the wireless communication unit 110. The mobile terminal 100 may also include at least two cameras 121.

The microphone 122 can receive an external audio signal in a call mode, a recording mode and/or a speech recognition mode, and the microphone 122 can process the received audio signal into electric audio data. The audio data may then be converted into a form that can be transmitted to a mobile communication base station through the mobile communication module 112 and output in the call mode. The microphone 122 may employ various noise removal algorithms (or noise canceling algorithm) for removing or reducing noise generated when the external audio signal is received.

The user input unit 130 can receive input data for controlling operation of the mobile terminal 100 from a user. The user input unit 130 may include a keypad, a dome switch, a touch pad (constant voltage/capacitance), a jog wheel, a jog switch and/or so on.

The sensing unit 140 can sense a current state of the mobile terminal 100, such as an open/close state of the mobile terminal 100, a position of the mobile terminal 100, whether a user touches the mobile terminal 100, a direction of the mobile terminal 100, and acceleration/deceleration of the mobile terminal 100, and the sensing unit 140 can generate a sensing signal for controlling operation of the mobile terminal 100. For example, in a slide phone, the sensing unit 140 can sense whether the slide phone is opened or closed. Further, the sensing unit 140 can sense whether the power supply 190 supplies power and/or whether the interface 170 is connected to an external device. The sensing unit 140 may also include a proximity sensor 141. The sensing unit 140 can also sense a motion of the mobile terminal 100.

The output unit 150 can generate visual, auditory and/or tactile output, and the output unit 150 may include the display module 151, an audio output module 152, an alarm module4 153 and a haptic module 154. The display module 151 can display information processed by the mobile terminal 100. The display module 151 can display a user interface (UI) and/or a graphic user interface (GUI) related to a telephone call when the mobile terminal 100 is in the call mode. The display module 151 can also display a captured and/or received image, a UI or a GUI when the mobile terminal 100 is in the video telephony mode or the photographing mode.

The display module 151 may include at least one of a liquid crystal display, a thin film transistor liquid crystal display, an organic light-emitting diode display, a flexible display and/or a three-dimensional display. The display module 151 may be of a transparent type or a light transmissive type. That is, the display module 151 may include a transparent display.

The transparent display may be a transparent liquid crystal display. A rear structure of the display module 151 may also be of a light transmissive type. Accordingly, a user may see an object located behind the body (of the mobile terminal 100) through the transparent area of the body of the mobile terminal 100 that is occupied by the display module 151.

The mobile terminal 100 may also include at least two displays 151. For example, the mobile terminal 100 may include a plurality of displays 151 that are arranged on a single face at a predetermined distance or integrated displays. The plurality of displays 151 may also be arranged on different sides.

When the display module 151 and a sensor sensing touch (hereafter referred to as a touch sensor) form a layered structure that is referred to as a touch screen, the display module 151 may be used as an input device in addition to an output device. The touch sensor may be in the form of a touch film, a touch sheet, and/or a touch pad, for example.

The touch sensor can convert a variation in pressure applied to a specific portion of the display module 151 or a variation in capacitance generated at a specific portion of the display module 151 into an electric input signal. The touch sensor can also sense pressure of touch as well as position and area of the touch.

When the user applies a touch input to the touch sensor, a signal corresponding to the touch input may be transmitted to a touch controller. The touch controller can then process the signal and transmit data corresponding to the processed signal to the controller 180. Accordingly, the controller 180 can detect a touched portion of the display module 151.

The proximity sensor 141 (of the sensing unit 140) may be located in an internal region of the mobile terminal 100, surrounded by the touch screen, and/or near the touch screen. The proximity sensor 141 can sense an object approaching a predetermined sensing face or an object located near the proximity sensor 141 using an electromagnetic force or infrared rays without having mechanical contact. The proximity sensor 141 may have a lifetime longer than a contact sensor and may thus have a wide application in the mobile terminal 100.

The proximity sensor 141 may include a transmission type photo-electric sensor, a direct reflection type photo-electric sensor, a mirror reflection type photo-electric sensor, a high-frequency oscillating proximity sensor, a capacitive proximity sensor, a magnetic proximity sensor, and/or an infrared proximity sensor. A capacitive touch screen may be constructed such that proximity of a pointer is detected through a variation in an electric field according to the proximity of the pointer. The touch screen (touch sensor) may be classified as a proximity sensor 141.

For ease of explanation, an action of the pointer approaching the touch screen without actually touching the touch screen may be referred to as a proximity touch and an action of bringing the pointer into contact with the touch screen may be referred to as a contact touch. The proximity touch point of the pointer on the touch screen may correspond to a point of the touch screen at which the pointer is perpendicular to the touch screen.

The proximity sensor 141 can sense the proximity touch and a proximity touch pattern (e.g., a proximity touch distance, a proximity touch direction, a proximity touch velocity, a proximity touch time, a proximity touch position, a proximity touch moving state, etc.). Information corresponding to the sensed proximity touch action and proximity touch pattern may then be displayed on the touch screen. A posture detection sensor 142 can also detect a posture of the mobile terminal 100.

The audio output module 152 can output audio data received from the wireless communication unit 110 or stored in the memory 160 in a call signal receiving mode, a telephone call mode or a recording mode, a speech recognition mode and a broadcasting receiving mode. The audio output module 152 may output audio signals related to functions, such as a call signal incoming tone and a message incoming tone, performed in the mobile terminal 100. The audio output module 152 may include a receiver, a speaker, a buzzer, and/or the like. The audio output module 152 may output sounds through an earphone jack. The user may hear the sounds by connecting an earphone to the earphone jack.

The alarm module 153 can output a signal for indicating generation of an event of the mobile terminal 100. For example, an alarm may be generated when receiving a call signal, receiving a message, inputting a key signal, and/or inputting a touch. The alarm module 153 can also output signals in forms different from video signals or audio signals, for example, a signal for indicating generation of an event through vibration. The video signals and/or the audio signals may also be output through the display module 151 or the audio output module 152.

The haptic module 154 can generate various haptic effects that the user can feel. One example of the haptic effects is vibration. An intensity and/or pattern of vibration generated by the haptic module 154 may also be controlled. For example, different vibrations may be combined and output or may be sequentially output.

The haptic module 154 can generate a variety of haptic effects including an effect of stimulus according to an arrangement of pins vertically moving against a contact skin surface, an effect of stimulus according to a jet force or sucking force of air through a jet hole or a sucking hole, an effect of stimulus of rubbing the skin, an effect of stimulus according to contact of an electrode, an effect of stimulus using an electrostatic force, and an effect according to a reproduction of cold and warmth using an element capable of absorbing or radiating heat in addition to vibrations.

The haptic module 154 may not only transmit haptic effects through direct contact but may also allow the user to feel haptic effects through a kinesthetic sense of the user's fingers or arms. The mobile terminal 100 may also include a plurality of haptic modules 154.

The memory 160 can store a program for operations of the controller 180 and/or temporarily store input/output data such as a phone book, messages, still images, and/or moving images. The memory 160 can also store data about vibrations and sounds in various patterns that are output from when a touch input is applied to the touch screen.

The memory 160 may include at least a flash memory, a hard disk type memory, a multimedia card micro type memory, a card type memory, such as SD or XD memory, a random access memory (RAM), a static RAM (SRAM), a read-only memory (ROM), an electrically erasable programmable ROM (EEPROM), a programmable ROM (PROM) magnetic memory, a magnetic disk and/or an optical disk. The mobile terminal 100 may also operate in relation to a web storage that performs a storing function of the memory 160 on the Internet.

The interface 170 can serve as a path to external devices connected to the mobile terminal 100. The interface 170 may receive data from the external devices or power and transmit the data or power to internal components of the mobile terminal 100 or transmit data of the mobile terminal 100 to the external devices. For example, the interface 170 may include a wired/wireless headset port, an external charger port, a wired/wireless data port, a memory card port, a port for connecting a device having a user identification module, an audio I/O port, a video I/O port, and/or an earphone port.

The interface 170 can also interface with a user identification module that is a chip that stores information for authenticating authority to use the mobile terminal 100. For example, the user identification module may be a user identify module (UIM), a subscriber identify module (SIM) and/or a universal subscriber identify module (USIM). An identification device (including the user identification module) may also be manufactured in the form of a smart card. Accordingly, the identification device may be connected to the mobile terminal 100 through a port of the interface 170.

The interface 170 may also be a path through which power from an external cradle is provided to the mobile terminal 100 when the mobile terminal 100 is connected to the external cradle or a path through which various command signals input by the user through the cradle are transmitted to the mobile terminal 100. The various command signals or power input from the cradle may be used as signals for confirming whether the mobile terminal 100 is correctly set in the cradle.

The controller 180 can control overall operations of the mobile terminal 100. For example, the controller 180 can perform control and processing for voice communication, data communication and/or video telephony. The controller 180 can also include a multimedia module 181 for playing multimedia. The multimedia module 181 may be included in the controller 180 or may be separated from the controller 180.

The controller 180 can perform a pattern recognition process capable of recognizing handwriting input or picture-drawing input applied to the touch screen as characters or images. The power supply 190 may receive external power and internal power and provide power required for operations of the components of the mobile terminal 100 under control of the controller 180.

According to a hardware implementation, embodiments may be implemented using at least one of application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, and/or electrical units for executing functions. Embodiments may be implemented by the controller 180.

According to a software implementation, embodiments such as procedures or functions may be implemented with a separate software module that executes at least one function or operation. Software codes may be implemented according to a software application written in an appropriate software language. The software codes may be stored in the memory 160 and executed by the controller 180.

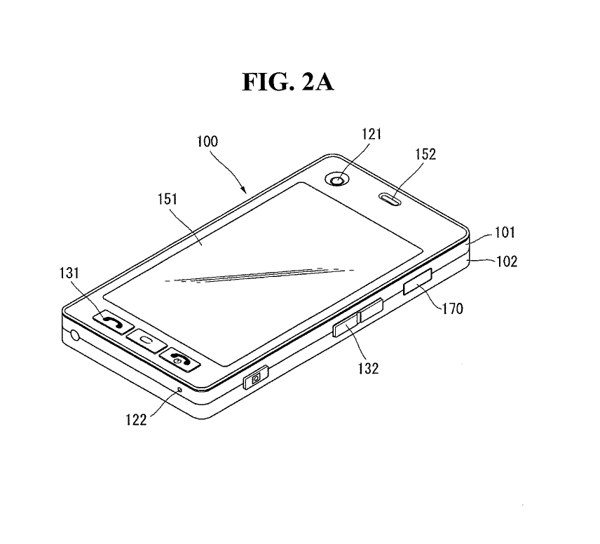

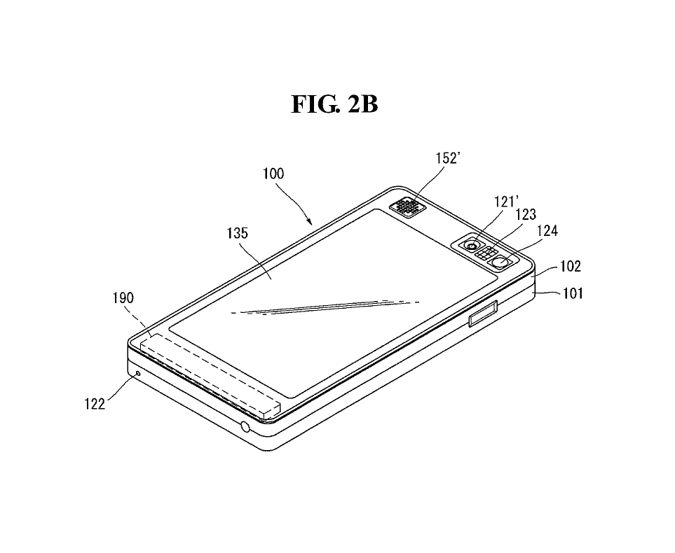

Next, FIG. 2A is a front perspective view of a mobile terminal (or a handheld terminal) according to an embodiment of the present invention. The mobile terminal 100 may be a bar type terminal body. However, embodiments are not limited to a bar type terminal and can be applied to terminals of various types including slide type, folder type, swing type and/or swivel type terminals having at least two bodies that are relatively movably combined.

The terminal body may include a case (a casing, a housing, a cover, etc.) that forms an exterior of the mobile terminal 100. In this embodiment, the case may be divided into a front case 101 and a rear case 102. Various electronic components may be arranged in the space formed between the front case 101 and the rear case 102. At least one middle case may be additionally provided between the front case 101 and the rear case 102.

The cases may be formed of plastics through injection molding or made of a metal material such as stainless steel (STS) or titanium (Ti).

The display module 151, the audio output unit 152, the camera 121, the user input unit 130/131 and 132, the microphone 122 and the interface 170 may be arranged (or provided) in the terminal body, and more specifically may be arranged (or provided) in the front case 101.

The display module 151 may occupy most of the main face of the front case 101. The audio output unit 152 and the camera 121 may be arranged in a region in proximity to one of both ends of the display module 151 and the user input unit 131, and the microphone 122 may be located in a region in proximity to another end of the display module 151. The user input unit 132 and the interface 170 may be arranged (or provided) on sides of the front case 101 and the rear case 102.

The user input unit 130 may receive commands for controlling operation of the mobile terminal 100, and may include a plurality of operating units 131 and 132. The operating units 131 and 132 may be referred to as manipulating portions and may employ any tactile manner in which a user operates the operating units 131 and 132 while having tactile feeling.

The first and second operating units 131 and 132 may receive various inputs. For example, the first operating unit 131 may receive commands such as start, end and scroll and the second operating unit 132 may receive commands such as control of a volume of sound output from the audio output unit 152 or conversion of the display module 151 to a touch recognition mode.

FIG. 2B is a rear perspective view of the mobile terminal (shown in FIG. 2A) according to an embodiment of the present invention. Referring to FIG. 2B, a camera 121′ may be additionally attached to the rear side of the terminal body (i.e., the rear case 102). The camera 121′ may have a photographing direction opposite to that of the camera 121 and may have pixels different from those of the camera 121 (shown in FIG. 2A).

For example, it may be preferable that the camera 121 has low pixels such that the camera 121 can capture an image of a face of a user and transmit the image to a receiving part for video telephony while the camera 121′ has high pixels because the camera 121′ captures an image of a general object and does not immediately transmit the image in many cases. The cameras 121 and 121′ may be attached (or provided) to the terminal body such that the cameras 121 and 121′ may rotate or pop-up.

A flash bulb 123 and a mirror 124 may be additionally provided in proximity to the camera 121′. The flash bulb 123 can light an object when the camera 121′ takes a picture of the object. The mirror 124 may be used for the user to look at his/her face in the mirror when the user wants to self-photograph himself/herself using the camera 121′.

An audio output unit 152′ may be additionally provided on the rear side of the terminal body. The audio output unit 152′ can achieve a stereo function with the audio output unit 152 and may be used for a speaker phone mode when the terminal is used for a telephone call.

A broadcasting signal receiving antenna may also be additionally attached (or provided) to the side of the terminal body in addition to an antenna for telephone calls. The antenna constructing a part of the broadcasting receiving module 111 may be set in the terminal body such that the antenna may be pulled out of the terminal body.

The power supply 190 for providing power to the mobile terminal 100 may be set in the terminal body. The power supply 190 may be included in the terminal body or may be detachably attached to the terminal body.

A touch pad 135 for sensing touch may be attached to the rear case 102. The touch pad 135 may be of a light transmission type, such as the display module 151. In this example, if the display module 151 outputs visual information through both sides thereof, the visual information may be recognized (or determined) by the touch pad 135. The information output through both sides of the display module 151 may be controlled by the touch pad 135. Otherwise, a display may be additionally attached (or provided) to the touch pad 135 such that a touch screen may be arranged (or provided) even in the rear case 102.

The touch pad 135 may operate in connection with the display module 151 of the front case 101. The touch pad 135 may be located in parallel with the display module 151 behind the display module 151. The touch panel 135 may be identical to or smaller than the display module 151 in size.

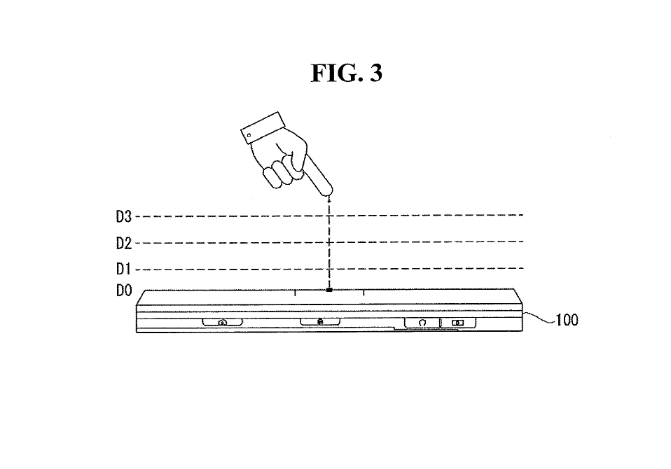

Next, FIG. 3 is a view illustrating a proximity depth of a proximity sensor. As shown in FIG. 3, when a pointer (such as a user's finger) approaches the touch screen, the proximity sensor located inside or near the touch screen may sense the approach of the pointer, and may output a proximity signal.

The proximity sensor may be constructed such that the proximity sensor outputs a proximity signal according to a distance between the pointer approaching the touch screen and the touch screen (referred to as “proximity depth”).

The distance in which the proximity signal is output when the pointer approaches the touch screen may be referred to as a detection distance. The proximity depth may be determined by using a plurality of proximity sensors having different detection distances and by comparing proximity signals respectively output from the proximity sensors.

FIG. 3 shows a section of the touch screen in which proximity sensors capable of sensing three proximity depths may be provided. Proximity sensors capable of sensing less than three or more than four proximity depths may be provided in the touch screen.

More specifically, when the pointer completely contacts the touch screen (D0), it may be recognized as contact touch. When the pointer is located within a distance D1 from the touch screen, it may be recognized as a proximity touch of a first proximity depth. When the pointer is located in a range between the distance D1 and a distance D2 from the touch screen, it may be recognized as a proximity touch of a second proximity depth. When the pointer is located in a range between the distance D2 and a distance D3 from the touch screen, it may be recognized as a proximity touch of a third proximity depth. When the pointer is located greater than the distance D3 from the touch screen, it may be recognized as cancellation of the proximity touch.

Accordingly, the controller 180 can recognize the proximity touch as various input signals according to proximity distance and proximity position of the pointer with respect to the touch screen, and the controller 810 may perform various operation controls according to the input signals.

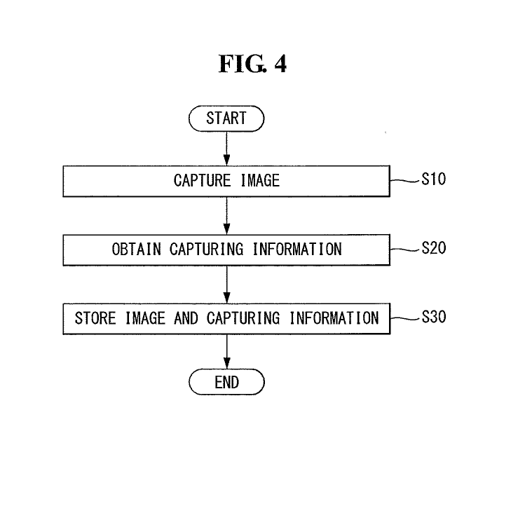

FIG. 4 is a flowchart illustrating an image capture operation of the mobile terminal according to an embodiment of the present invention. As shown in FIG. 4, the controller 180 captures an image (S10). For example, the image may be a picture captured by the camera 121.

In the following description, the camera 121 refers to a camera provided to the backside of the mobile terminal 100 unless otherwise mentioned. The image does not mean a specific image in the horizontal or vertical direction. For example, both images captured when the mobile terminal 100 is disposed in landscape and portrait can be images according to an embodiment of the present invention.

Further, the image may be a scenery image rather than a portrait. For example, the image may be a photo of a wide area, captured using the view angle of the camera 121. However, the scenery image is not limited to an image of scenery and may be an image of a person. That is, the term “scenery image” is used for convenience of understanding and includes the meaning of general images.

Subsequently, capturing information is acquired (S20). The capturing information may be at least one of capturing place information, capturing direction information and view angle information about the captured scenery image. For example, the capturing information may include location information about a place where the scenery image is captured using the camera 121, information about the direction of the camera 121, information about the view angle of the camera 121 capturing the scenery image, etc.

When at least one of the location information about the capturing place, information about the direction of the camera 121 and/or information about the view angle of the camera 121 are present, the controller 180 can calculate a photographed area corresponding to the scenery image based on the information. That is, the controller 180 can calculate the horizontal and vertical sizes of the captured area corresponding to the scenery image.

The scenery image and the capturing information are then stored (S30). The controller 180 can store the image captured using the camera 121 and the capturing information together or separately. For example, the capturing information may be added to the header and/or tail of an image file corresponding to the scenery image or a capturing information file corresponding to the capturing information may be separately generated and stored.

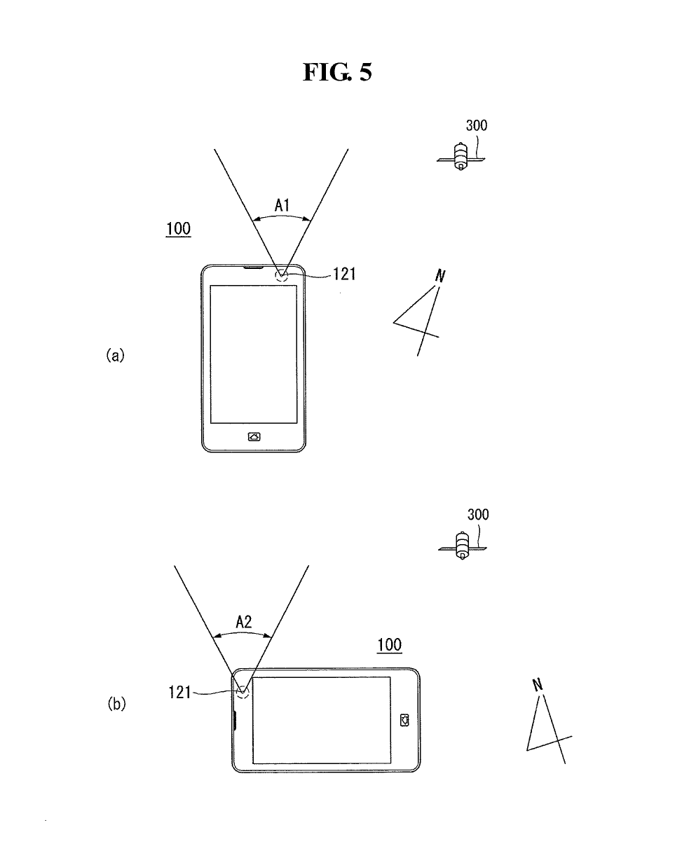

Next, FIGS. 5 to 7 illustrate a scenery image capture operation of the mobile terminal shown in FIG. 4. As shown in FIGS. 5 to 7, the mobile terminal 100 according to an embodiment of the present invention can store the scenery image CI captured by the camera 121 and the capturing information IF.

Referring to FIG. 5(a), a user can take a picture with the mobile terminal 100 in a portrait position. In this instance, the view angle of the camera 121 may be A1. Location information about the place where the scenery image is captured may be obtained from a satellite 300 simultaneously with, before or after the time when the scenery image is captured. In addition, information about the capturing direction may be obtained simultaneously with, before or after the time when the scenery image is captured.

Referring to FIG. 5(b), the user can take a picture with the mobile terminal in a landscape position. In this instance, the view angle of the camera 121 may be A2. The view angles A1 and A2 of the camera 121 may be identical to or different from each other. Further, the view angle of the camera 121 may also depend on a zoom-in/zoom-out degree.

When the user takes a picture with the mobile terminal 100 in the landscape position, the location information about the capturing place and information about the capturing direction can be obtained simultaneously with, before or after the time when the scenery image is captured.

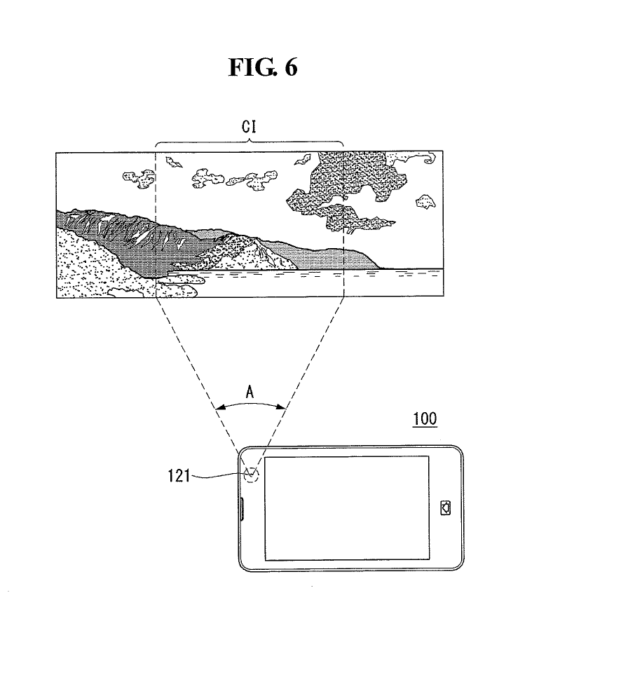

Referring to FIG. 6, the user can capture a scenery image using the mobile terminal 100. While real scenery spreads out omnidirectionally around the user carrying the mobile terminal 100, only a portion of the scenery can be captured as the scenery image CI due to the view angle A of the camera 121. The controller 180 can acquire the capturing information IF related to the scenery image CI when the scenery image CI is captured.

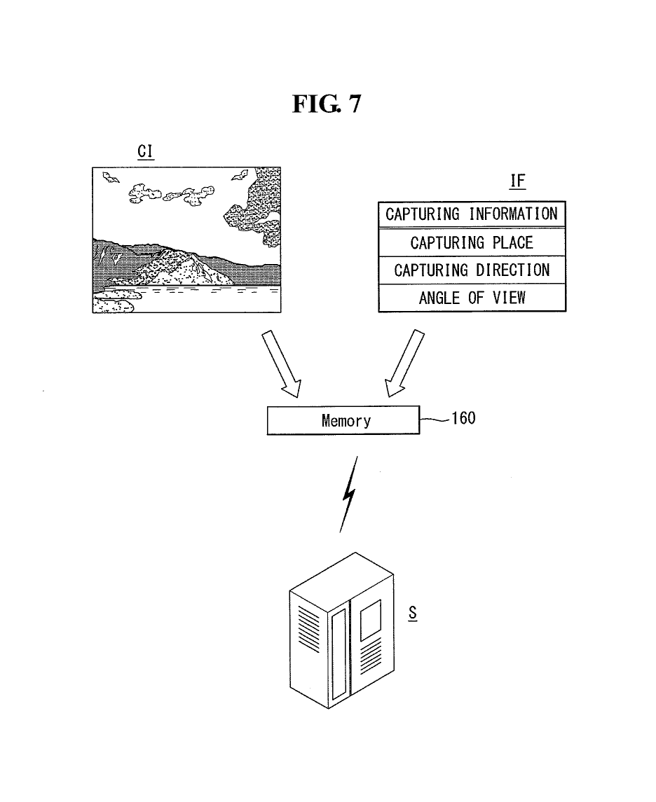

Referring to FIG. 7, data about the scenery image CI and data about the capturing information IF can be stored in the memory 160. As described above, the scenery image CI may correspond to part of the scenery, and the capturing information IF may include capturing place data, capturing direction data and view angle data.

The scenery image CI and the capturing information IF can be stored in the memory 160. Further, the scenery image CI and the capturing information IF may be stored in one file or separately stored in two or more files. The scenery image CI and the capturing information IF stored in the memory 160 may also be transmitted to a server S and then transmitted to another terminal.

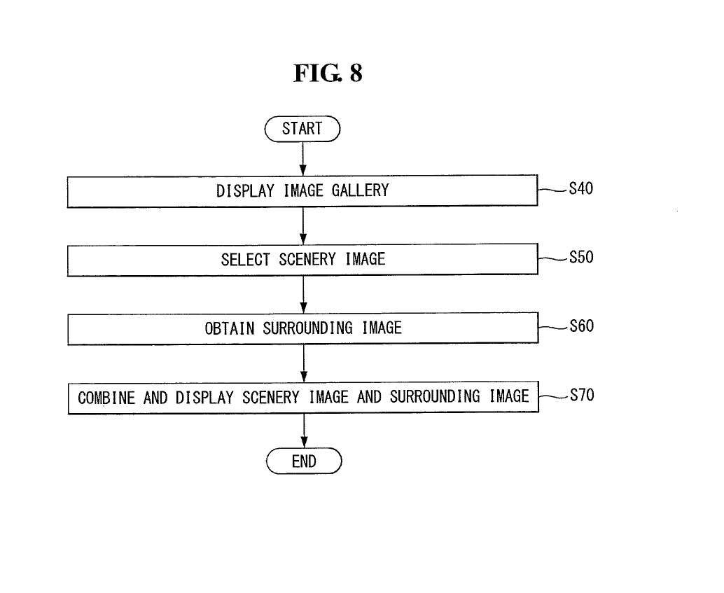

Next, FIG. 8 is a flowchart illustrating an image display operation of the mobile terminal according to an embodiment of the present invention. Referring to FIG. 8, the controller 180 can combine the scenery image CI with a surrounding image and display the combined image.

Specifically, an image gallery display step S40 and a scenery image selection step S50 may be performed. In addition, an image gallery corresponds to an application for displaying images stored in the mobile terminal 100 or captured images.

Further, the image gallery can display images in a form depending on the number, types, attributes, etc. of displayed images. For example, when a plurality of images are displayed in one screen, the images can be displayed as thumbnails or the size of the images can be adjusted according to the number of displayed images. In addition, when the scenery image CI is displayed, the image gallery may combine the scenery image CI with a surrounding image and display the combined image, which will be described in detail later. The user can also select the specific scenery image CI from the images displayed through the image gallery.

Further, as shown in FIG. 8, a surrounding image can be acquired (S60). The surrounding image may be an image related to the selected scenery image CI. For example, when part of scenery is captured as the scenery image CI, the surrounding image may be an image of the uncaptured remaining part. The surrounding image may also be an image captured by a user of another terminal. That is, the surrounding image may be an image related to the image captured by the user of the mobile terminal 100, from among images captured by many people using other terminals and uploaded to the server S.

The surrounding image can also be searched based on the capturing information included in the scenery image CI. For example, the surrounding image can be searched upon determination of the capturing place and captured object based on the capturing place information, capturing direction information and view angle information.

As shown in FIG. 8, the scenery image and the surrounding image can then be combined and displayed (S70). Specifically, the acquired surrounding image can be combined with the scenery image. That is, the scenery image and the surrounding image may be combined to generate one image.

A part which has not been captured by the user of the mobile terminal 100 can be displayed by combining and displaying the scenery image and the surrounding image. Furthermore, images captured by other users can be displayed with the image captured by the user of the mobile terminal 100 to improve user sensitive quality.

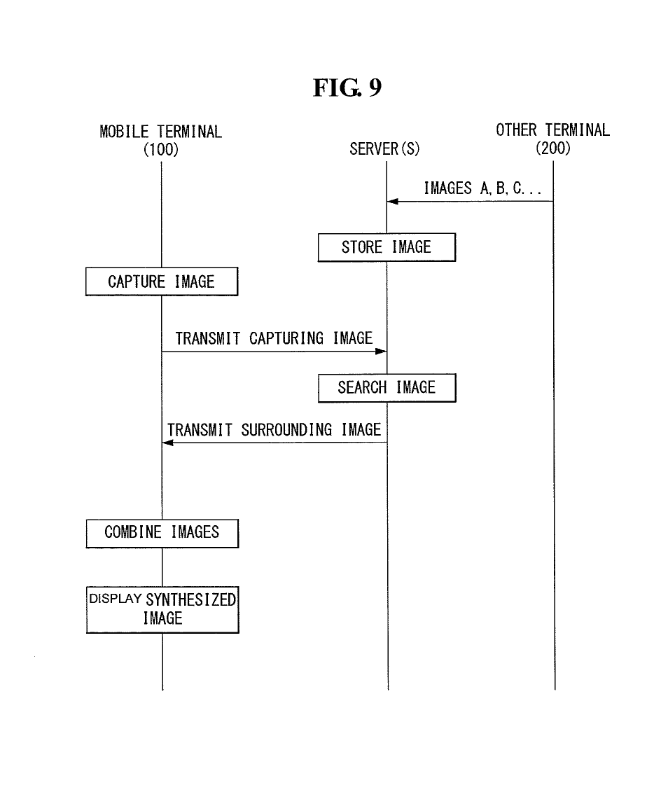

Next, FIG. 9 is a signal flow graph illustrating operation of the mobile terminal shown in FIG. 8. Referring to FIG. 9, the mobile terminal 100 according to an embodiment of the present invention can acquire an image from the server S.

The server S can obtain a plurality of images from another terminal 200 and store the images. The user of the mobile terminal 100 can also take a picture of scenery using the camera 121 of the mobile terminal 100.

Upon capture of the scenery image, the mobile terminal 100 can transmit the capturing information to the server S. The server S can search images pre-stored therein for a surrounding image related to the scenery image CI based on the transmitted capturing information. The server S can also transmit the searched surrounding image to the mobile terminal 100. As shown in FIG. 9, the mobile terminal 100 can combine the scenery image CI with the transmitted surrounding image and display the combined image.

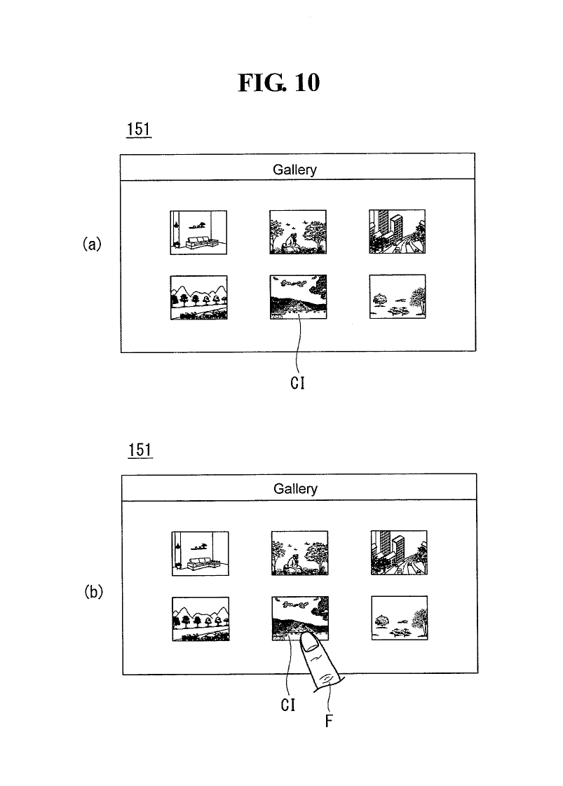

FIGS. 10 to 13 illustrate an image display procedure of the mobile terminal shown in FIG. 8. As shown in FIGS. 10 to 13, the mobile terminal 100 according to an embodiment of the present invention can display the selected scenery image CI in a form different from other images.

Referring to FIG. 10(a), the display module 151 can display the image gallery. As discussed above, the image gallery may include a plurality of pictures in the form of thumbnails and at least one of the pictures may be the scenery image CI.

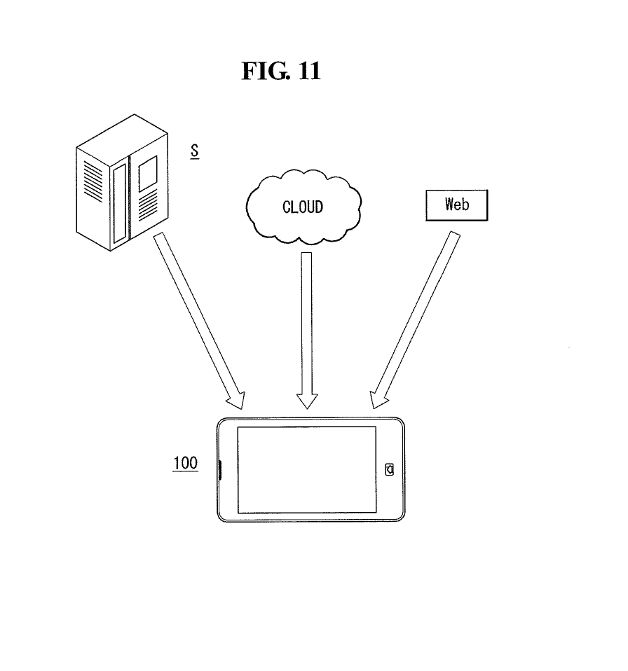

Referring to FIG. 10(b), the user can select the scenery image CI using a finger F. Referring to FIG. 11, the mobile terminal 100 can acquire surrounding images related to the scenery image CI through various means.

Acquisition of the surrounding images may be synchronized with one of capturing of the scenery image CI, selection of the scenery image CI and display of the scenery image CI. Further, the surrounding images may be acquired through the server S, cloud service, a web and the like. However, a method of acquiring surrounding images through the server S is just an example in the following description.

Surrounding images may be searched in the server S and transmitted to the mobile terminal 100. That is, upon transmission of the capturing information related to the scenery image CI to the server S, surrounding images corresponding to the scenery image CI may be searched and transmitted to the mobile terminal 100.

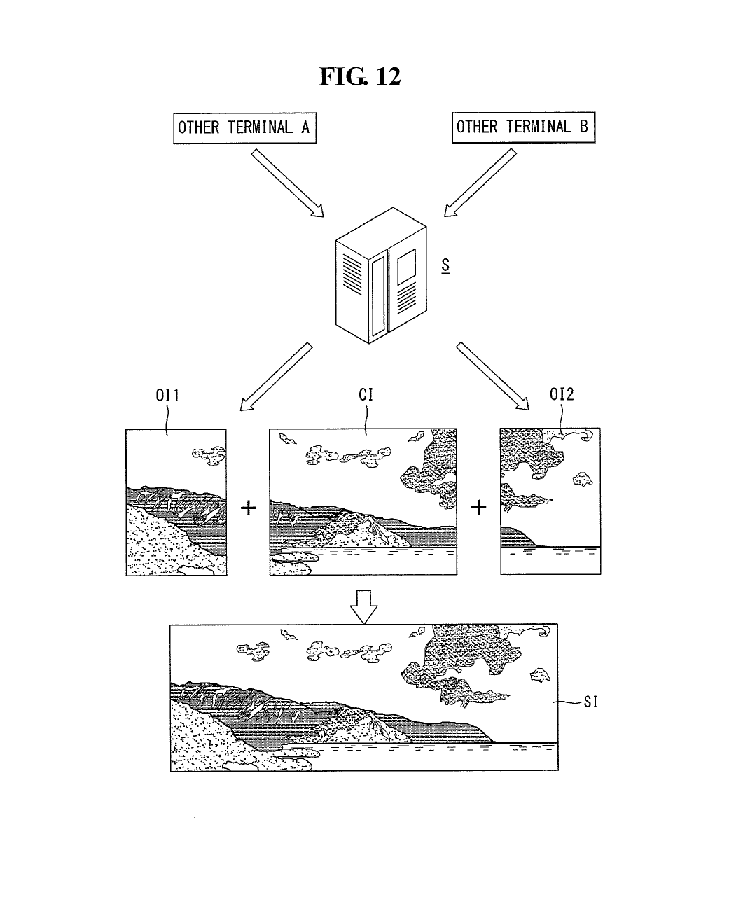

Referring to FIG. 12, the server S can acquire various images from other terminals A and B. The server S can search the acquired images for surrounding images OI1 and OI2 and transmit the surrounding images OI1 and OI2 to the mobile terminal 100 at the request of the mobile terminal 100.

Upon reception of the surrounding images OI1 and OI2, the mobile terminal 100 can combine the scenery image CI and the received surrounding images OI1 and OI2 to generate one synthesized image SI.

Further, the synthesized image SI may have a form in which the scenery image CI and the surrounding images OI1 and OI2 are combined in landscape. For example, a panorama image can be generated as the synthesized image SI. Considering that scenery can be well observed when photographed in landscape direction in general, a panorama image may be a useful method for representing scenery.

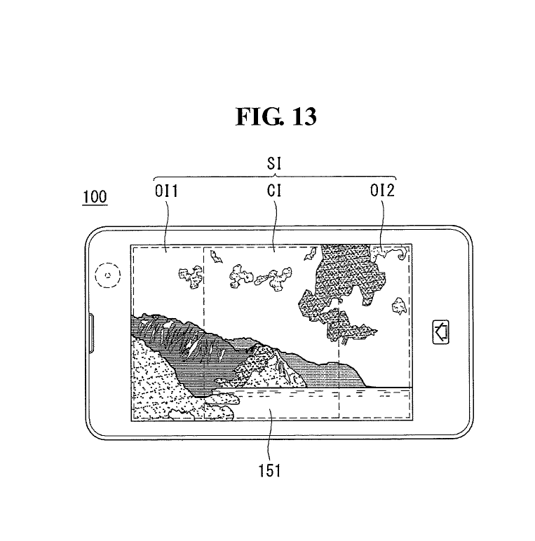

Referring to FIG. 13, the controller 180 can display the synthesized image SI on the display module 151. That is, the scenery image CI captured by the user of the mobile terminal 100 can be displayed along with the surrounding images OI1 and OI2 related to the scenery image CI. Accordingly, the user can view the image of the place, which is not captured when the scenery image CI is captured.

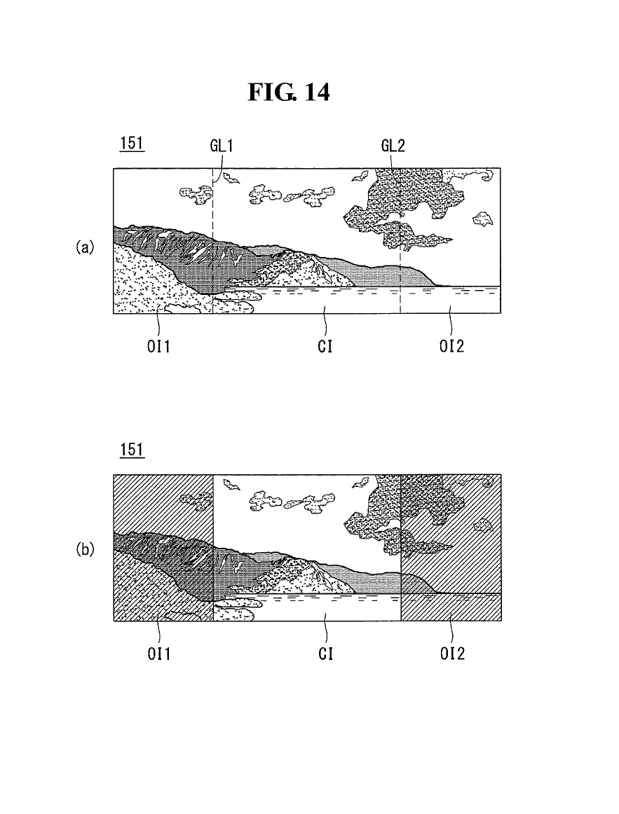

Next, FIGS. 14 to 16 are overviews illustrating another image display method of the mobile terminal shown in FIG. 8. Referring to FIGS. 14 to 16, the controller 180 can generate and display the synthesized image SI in various manners.

Referring to FIG. 14(a), the controller 180 can display the synthesized image SI so the scenery image CI captured by the user of the mobile terminal 100 is distinguished from the obtained surrounding images OI1 and OI2. For example, first and second guide lines GL1 and GL2 may be displayed on the synthesized image SI. The first and second guide lines GL1 and GL2 may be displayed on the boundaries between the scenery image CI captured by the user and the obtained surrounding images OI1 and OI2.

Referring to FIG. 14(b), the controller 180 can blur the surrounding images OI1 and OI2 or display the surrounding images OI1 and OI2 in a different color or different chroma in order to distinguish the surrounding images OI1 and OI2 from the scenery image CI. When the scenery image CI captured by the user of the mobile terminal 100 and the surrounding images OI1 and OI2 obtained from the server S or the like are displayed such that they are distinguished from each other, as described above, the user can distinctly recognize the part of the synthesized image SI, which is captured by them.

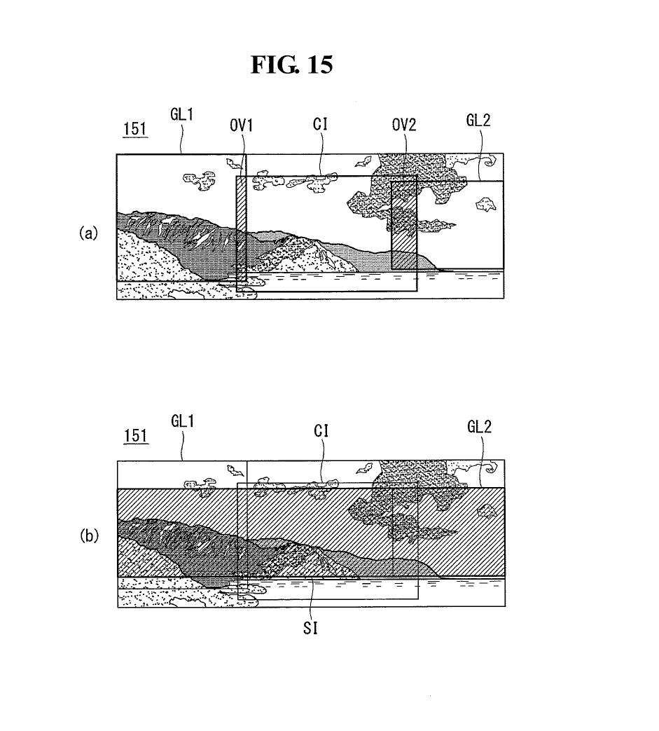

Referring to FIG. 15(a), the scenery image CI captured by the user may differ from the surrounding images OI1 and OI2 obtained from the server S or the like in terms of position, size and the like. For example, the vertical length of the scenery image CI may be greater than that of the first surrounding image OI1 and the upper end and/or the lower end of the scenery image CI may not correspond to those of the first surrounding image OI1. Furthermore, a first overlap area OV1 of the scenery image CI and the first surrounding image OI1 may be generated. This size mismatch may be generated between the scenery image CI and the second surrounding image OI2. In addition, the scenery image CI may not be flush with the surrounding images OI1 and OI2.

Referring to FIG. 15(b), when the scenery image CI and the surrounding images OI1 and OI2 are not matched to each other, the controller 180 of the mobile terminal 100 can correct the scenery image CI and the surrounding images OI1 and OI2 to generate the synthesized image SI. For example, the synthesized image SI may be generated in the size of a smaller one of the scenery image CI or the surrounding images OI1 and OI2. An overlap region of the scenery image CI and the surrounding images OI1 and OI2 may be blurred or cropped to generate the synthesized image SI in an appropriate form.

When the scenery image CI is not flush with the surrounding images OI1 and OI2, a reference horizontal line may be determined and the images may be rotated clockwise and/or counter clockwise to be aligned with the reference horizontal line so as to generate the synthesized image.

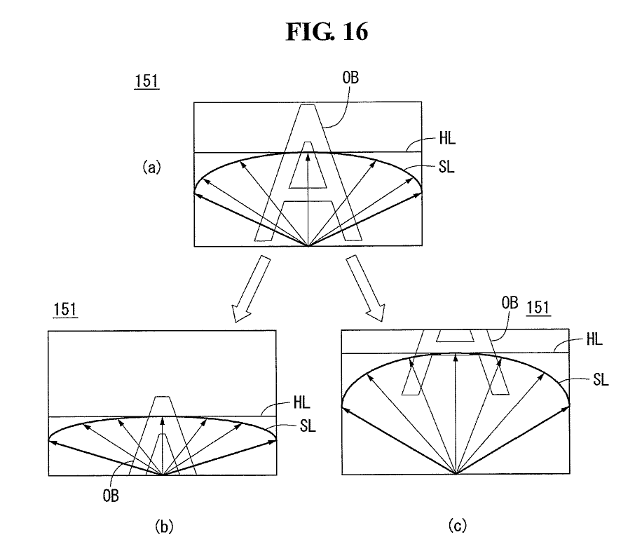

Referring to FIG. 16(a), an object OB photographed using the camera 121 can be displayed on the display module 151. A whole or part of the object OB can be captured by the user gripping the mobile terminal 100. In FIG. 16(a), it is assumed that the user photographs the object OB in an ideal position. That is, the user properly grips the camera 121 toward the object OB such that the whole object OB can be displayed.

The virtual horizontal line HL may be located around the center of the display module 151 when the camera 121 correctly photographs the object OB. In addition, a virtual equidistance line SL obtained by connecting distances equal to a distance between a specific point on the display module 151 and the virtual horizontal line HL may be displayed.

Referring to FIG. 16(b), the user may move the camera 121 toward the sky. That is, the user may tilt the mobile terminal 100. Upon tilting of the camera 121 toward the sky, the upper part of the object OB may be photographed. Furthermore, the virtual horizontal line HL is moved downward and the equidistance line SL from the specific point on the display module 151 to the virtual horizontal line HL is shortened.

Referring to FIG. 16(c), the user may tilt the camera 121 toward the ground. Then, the lower part of the object OB may be photographed and the virtual horizontal line HL and the equidistance line SL may be moved upward.

The synthesized image SI of the scenery image CI and the surrounding images OI1 and OI2 can be generated based on movement of the virtual horizontal line HL and the equidistance line SL according to the capturing direction of the camera 121. For example, when the scenery image CI is captured by photographing the corresponding object close and the surrounding images OI1 and OI2 are captured by photographing the object from a distance, the images can be edited to be balanced by magnifying one of the scenery image CI and the surrounding images OI1 and OI2 and reducing the other.

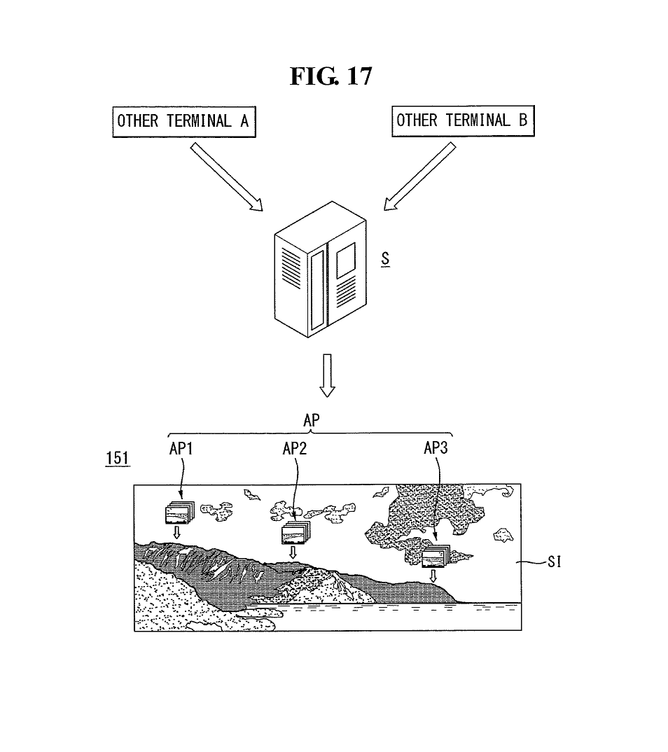

Next, FIGS. 17 to 22 are overviews illustrating an operation of the mobile terminal shown in FIG. 8. Referring to FIGS. 17 to 22, the controller 180 can obtain and display various additional images AP. The additional images AP may be images captured by the user of the mobile terminal 100 and/or users of other terminals within the range of the currently displayed synthesized image SI. When the additional images AP are displayed, the user can access a larger number of images through the synthesized image SI.

The additional images AP may be obtained through the server S and the like. In addition, the server S can obtain the additional images AP from other terminals A and B. Further, the additional images AP may be displayed in the form of thumbnails on the synthesized image SI and may be displayed in positions corresponding to points where the additional images AP are captured. For example, first, second and third additional images AP1, AP2 and AP3 may be respectively captured in first, second and third places PL1, PL2 and PL3. In this instance, the controller 180 can display the first, second and third additional images AP in positions corresponding to the first, second and third places PL1, PL2 and PL3 on the synthesized image SI, respectively.

A plurality of additional images AP captured in a specific place may be present. In this instance, the additional images AP in the faun of thumbnails may be displayed in an overlapping manner such that the user can easily recognize that the multiple additional images AP are present.

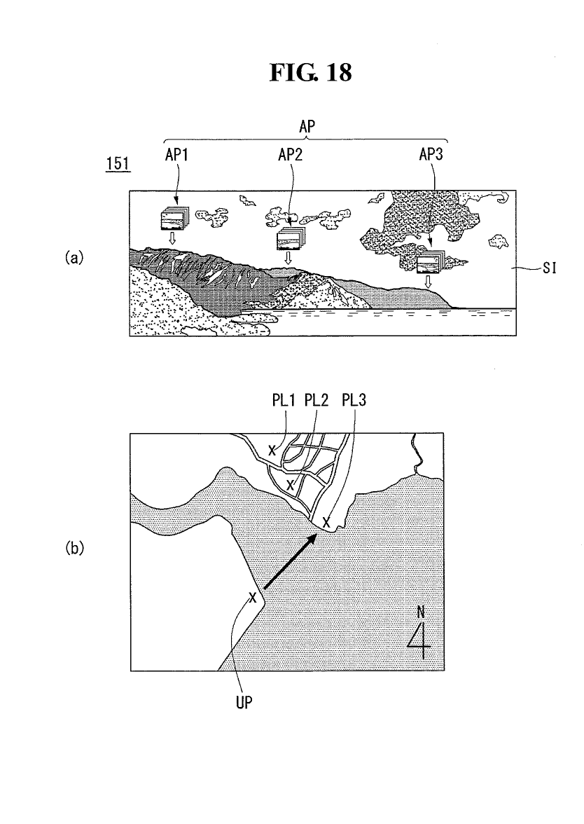

Referring to FIG. 18(a), the first, second and third additional images AP1, AP2 and AP3 may be displayed in the corresponding positions on the synthesized image SI.

Referring to FIG. 18(b), the user can photograph northeast scenery from a photographing position UP. The synthesized image SI generated by combining the scenery image CI captured by the user and the obtained surrounding images OI1 and OI2 may include the first, second and third places PL1, PL2 and PL3.

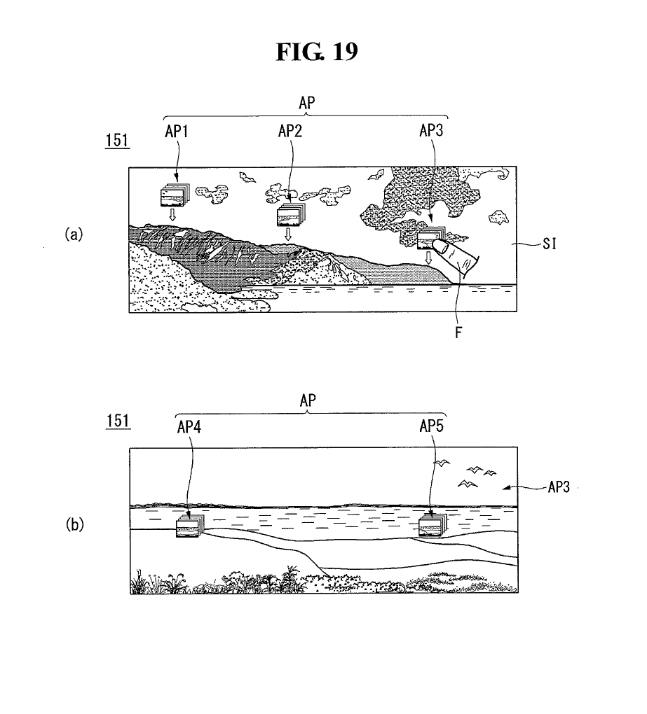

Referring to FIG. 19(a), the user can select a specific additional image AP. For example, the third additional image AP3 may be selected using a finger F. Upon selection of the specific additional image, the controller 180 can display the selected additional image AP on the display module 151.

Referring to FIG. 19(b), the display module 151 can display the selected third additional image AP3. The third additional image AP3 may include fourth and fifth additional images AP4 and AP5. That is, images, which are captured by the user of the mobile terminal 100 and/or users of other terminals in the range of the third additional image AP3, may be displayed.

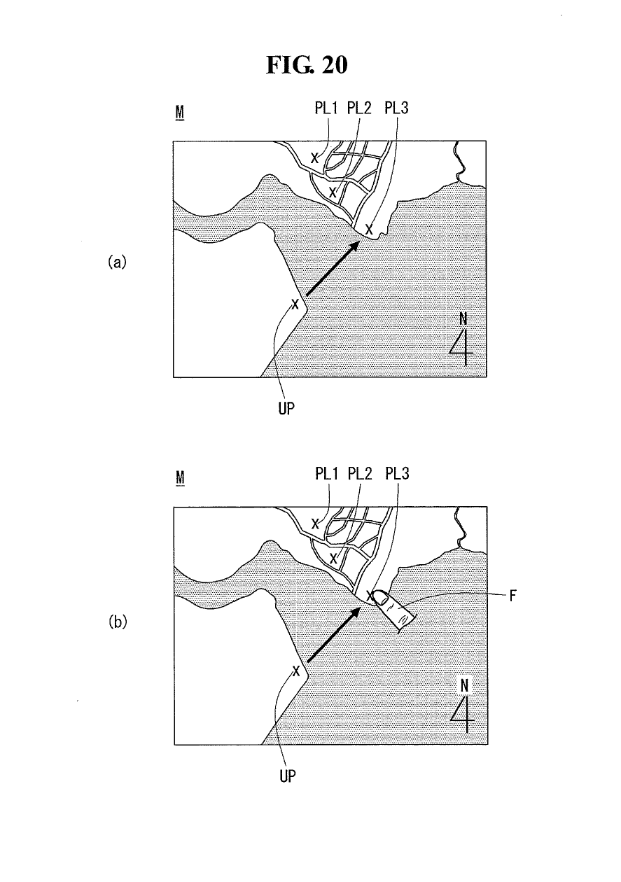

Referring to FIG. 20(a), the relationship between images may be displayed as a map image M. For example, the initial image may be an image captured in the photographing position UP. The first, second and third places PL1, PL2 and PL3 where the additional images are captured may be located in proximity to the photographing position UP. Referring to FIG. 20(b), the user can select the third place PL3 using a finger F.

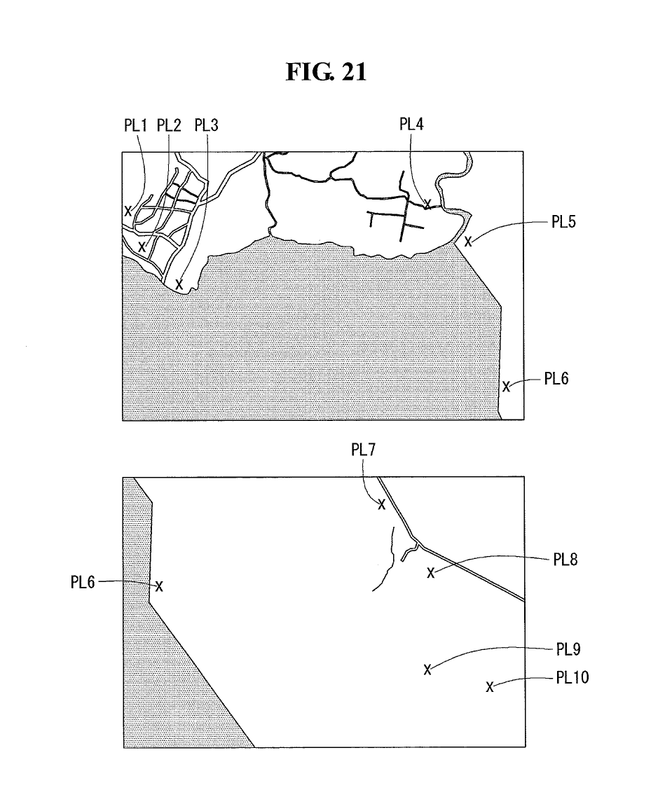

Referring to FIG. 21(a), upon selection of the third place PL3 by the user, fourth, fifth and sixth additional places PL4, PL5 and PL6 corresponding to images related to the third place PL3 can be displayed on the map image M. Referring to FIG. 21(b), upon selection of the sixth additional place PL6 by the user, seventh to tenth additional places PL7 to PL10 corresponding to images related to the sixth additional place PL6 can be displayed.

When a specific place is selected, the user is informed of other places corresponding to images related to the specific place and thus can sequentially recognize related images. Accordingly, the user can recollect places they visited and recall memories associated with the places through the images.

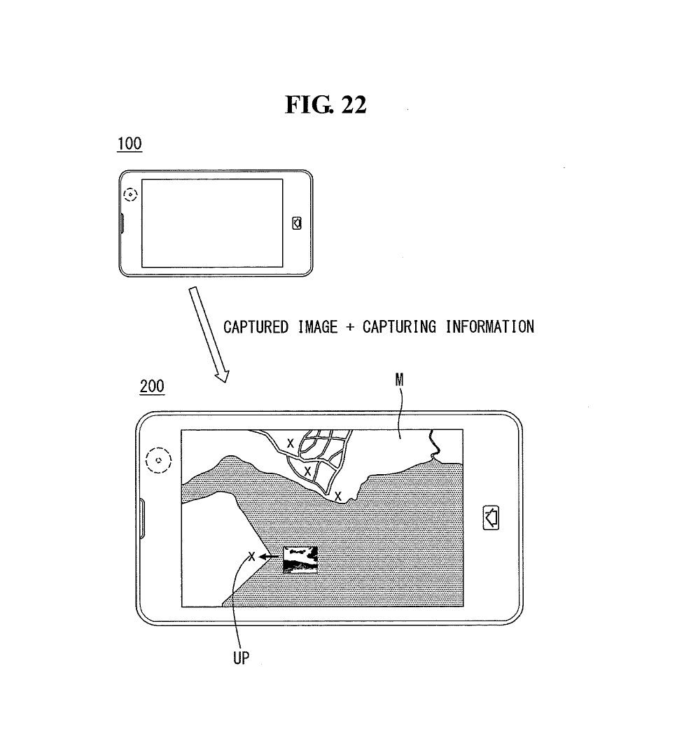

Referring to FIG. 22, the captured image obtained using the mobile terminal 100 may be transmitted along with capturing information to another terminal 200 directly or via the server S. Upon acquisition of the captured image with the capturing information, the other terminal 200 can display the obtained captured image along with the photographing position UP on the map image M.

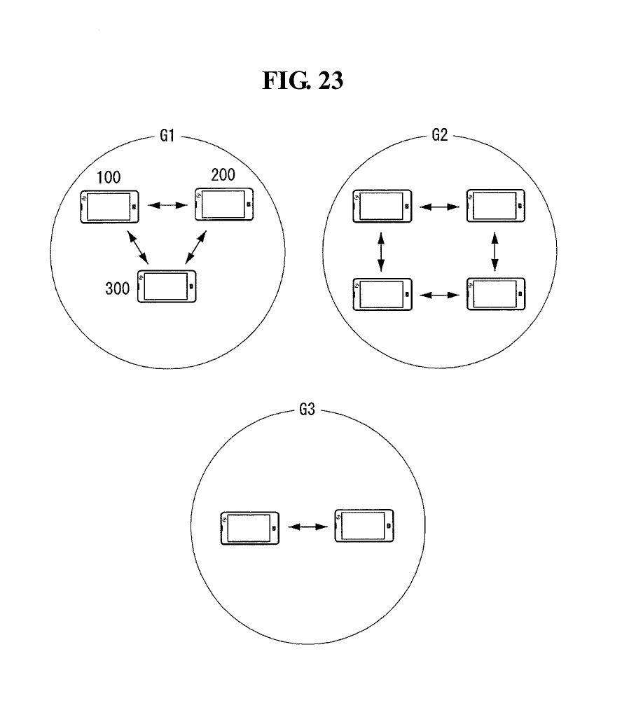

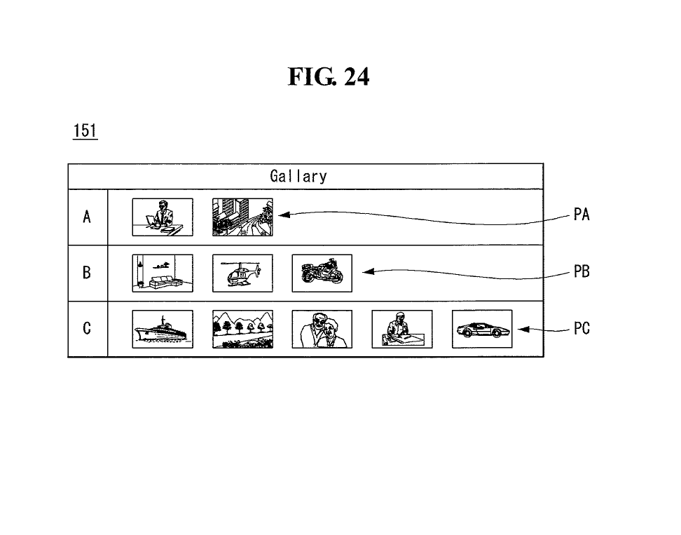

Next, FIGS. 23 and 24 illustrate a gallery display method of the mobile terminal shown in FIG. 8. Referring to FIGS. 23 and 24, the controller 180 can exchange images among users in a group more conveniently.

Referring to FIG. 23, a plurality of terminal groups may be present. For example, first, second and third mobile terminals 100, 200 and 300 may form a first group G1. Second and third groups G2 and G3 are also shown. A specific group may be formed by grouping terminals which use the same SNS or frequently communicate or may be set by the user. In addition, the controller 180 can control image exchange between users in a specific group to be easily performed. Furthermore, the controller 180 can sort exchanged images per user and display the sorted images.

Referring to FIG. 24, the user of the mobile terminal 100 may be A. The display module 151 can display images obtained from users B and C belonging to the same group. That is, first pictures PA captured by user A, second pictures PB captured by user B and third pictures PC captured by user C can be displayed on a screen of the gallery so the first pictures PA, the second pictures PB and the third pictures PC are discriminated.

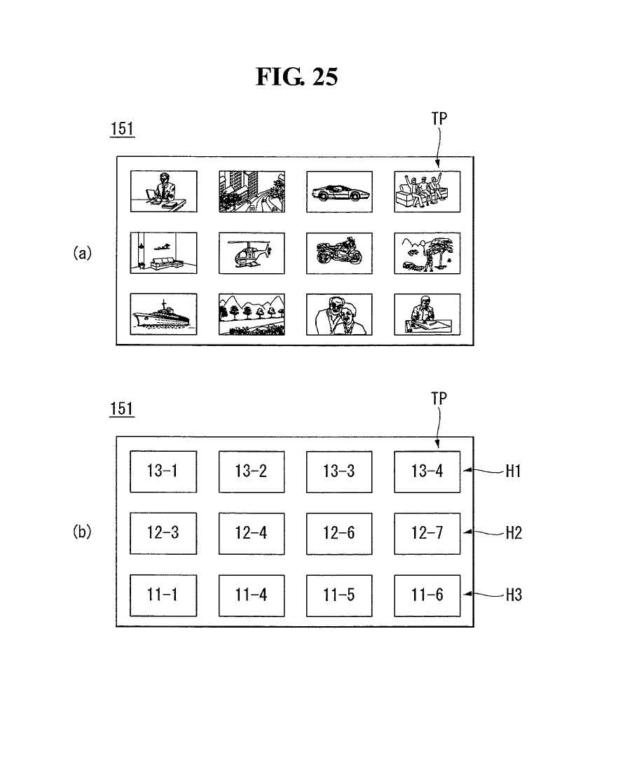

Next, FIGS. 25 to 27 illustrate another gallery display method of the mobile terminal shown in FIG. 8. Referring to FIGS. 25 to 27, the controller 180 can arrange images captured by the user of the mobile terminal 100 and/or images obtained from other terminals in order of time and display the images.

Referring to FIG. 25(a), the gallery can display a plurality of images as thumbnails TP. The horizontal axis of the thumbnails TP may be associated with capturing time of the corresponding images.

Referring to FIG. 25(b), the thumbnails TP are represented by the years and months when the corresponding images are generated. That is, the thumbnails TP are represented in order of “year in two digits” and “month.” However, the thumbnails are not displayed in this form on the display module 151 and representation of the thumbnails in this manner is a method for clarifying arrangement of thumbnails based on generation time.

The thumbnails TP may be horizontally arranged in first, second and third lines H1, H2 and H3. Images captured in 2013 may be arranged in the first line H1, images captured in 2012 may be arranged in the second line H2 and images captured in 2011 may be arranged in the third line H3.

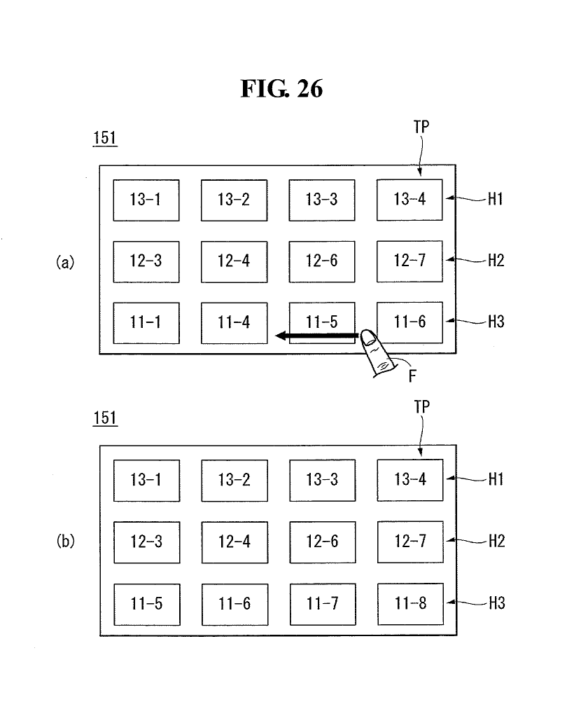

Referring to FIG. 26(a) and (b), the user can touch the third line H3 and drag the touch in a specific direction. The thumbnails of the third line H3 may be sequentially moved to the left or right in response to touch-and-drag operation of the user. The thumbnails of the third line H3 may be changed according to touch-and-drag operation of the user.

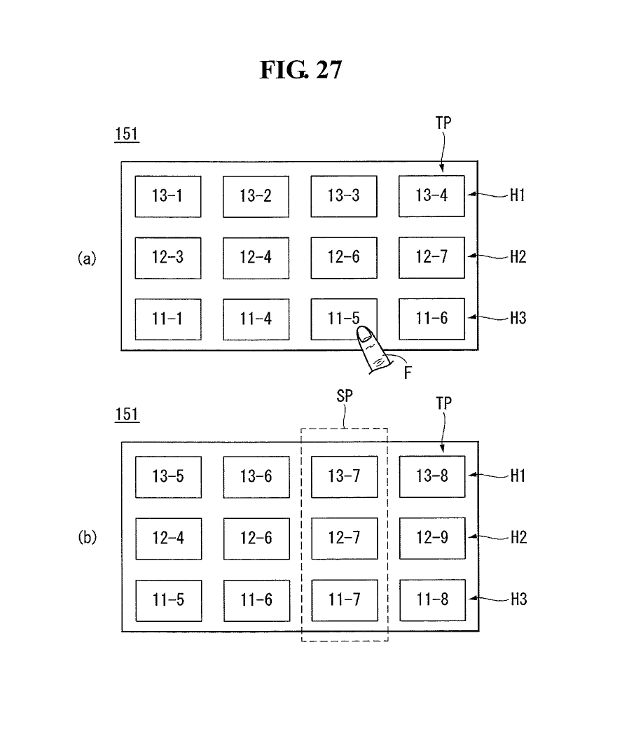

Referring to FIG. 27(a), the user can select a specific thumbnail using a finger F. For example, image 11-7 of the third line H3 may be selected. Referring to FIG. 27(b), when the user selects image 11-7, that is, the image captured in July 2011, the controller 180 can automatically align the first line H1 and the second line H2. That is, the image captured in July 2012 and the image captured in July 2013 may be vertically arranged (SP) above image 11-7.

Image alignment may be performed in various manners. For example, pictures captured in the same and/or similar places may be aligned, pictures of a specific person may be aligned or pictures that do not include a specific person may be aligned.

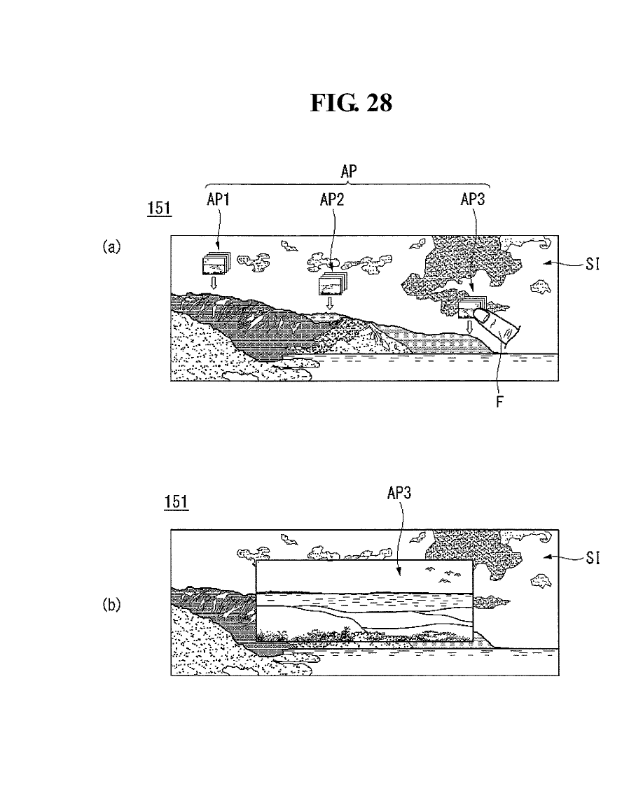

Next, FIGS. 28 to 31 illustrate another gallery display method of the mobile terminal shown in FIG. 8. As shown in FIGS. 28 to 31, the controller 180 can display additional images AP through various methods. Referring to FIG. 28(a), additional images AP may be displayed on the synthesized image SI. The user can select the third additional image AP3 using a finger F.

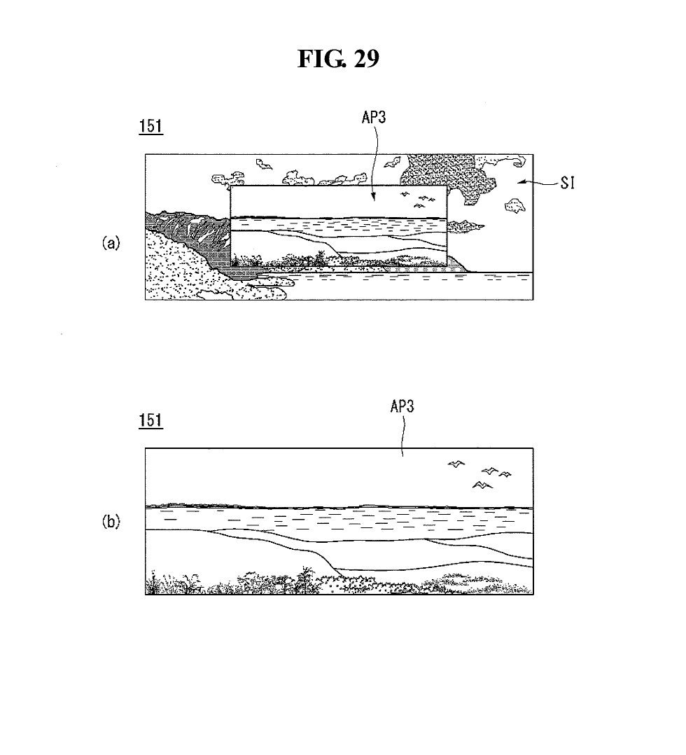

Referring to FIGS. 28(b) and 29(a), upon selection of the third additional image AP3 by the user, the third additional image AP3 may be gradually magnified. Then, the user can feel as if they move from the place corresponding to the synthesized image SI to the place corresponding to the third additional image AP3.

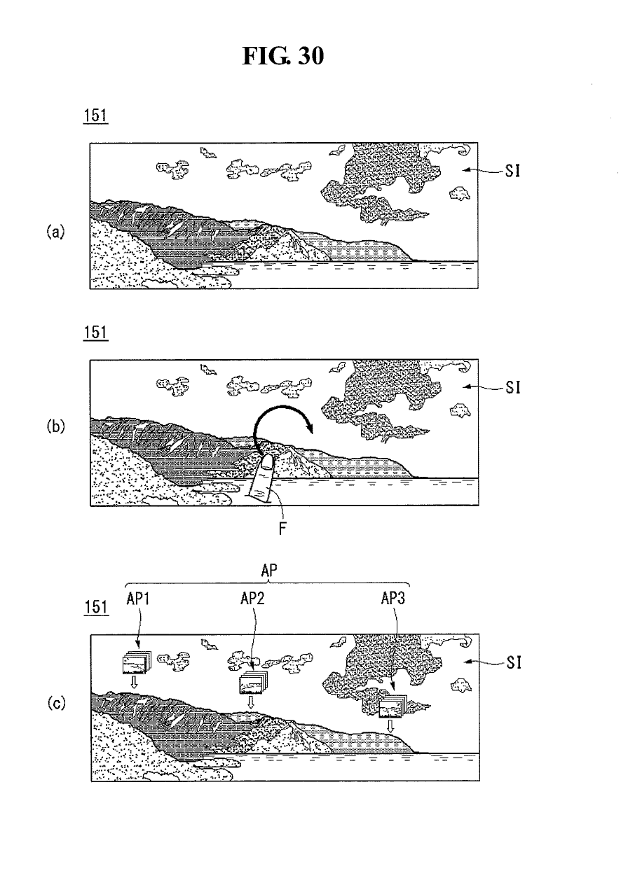

Referring to FIG. 29(b), the selected third additional image AP3 may be magnified to full screen of the display module 151. Referring to FIG. 30(a), the synthesized image SI may be displayed on the display module 151.

Referring to FIG. 30(b), the user can perform a specific touch operation on the synthesized image SI using a finger F. For example, the user can perform touch operation of rotating clockwise.

Referring to FIG. 30(c), when the user performs a predetermined specific gesture touch operation, the controller 180 can display additional images AP on the synthesized image SI. Furthermore, when the user performs a predetermined specific gesture touch operation while the additional images AP are displayed, display of the additional images AP may be terminated.

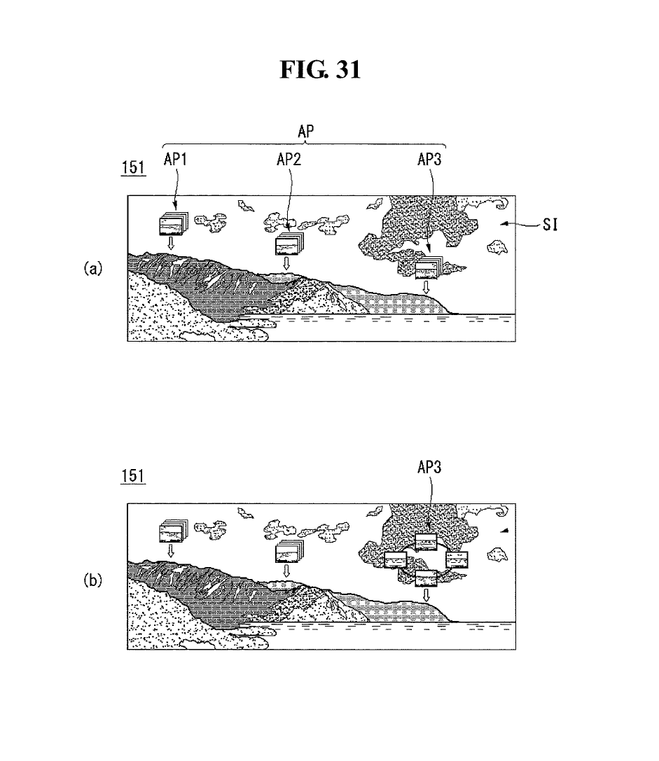

Referring to FIG. 31(a), the display module 151 can display the additional images AP. When a plurality of additional images AP of a specific place is present, the images AP can be displayed in an overlapping manner, as described above.

Referring to FIG. 31(b), all or some additional images AP may be displayed such that the additional images AP do not overlap. For example, when manipulation of the user is applied, the controller 180 can arrange the additional images AP on a circular trajectory such that the additional images AP do not overlap.

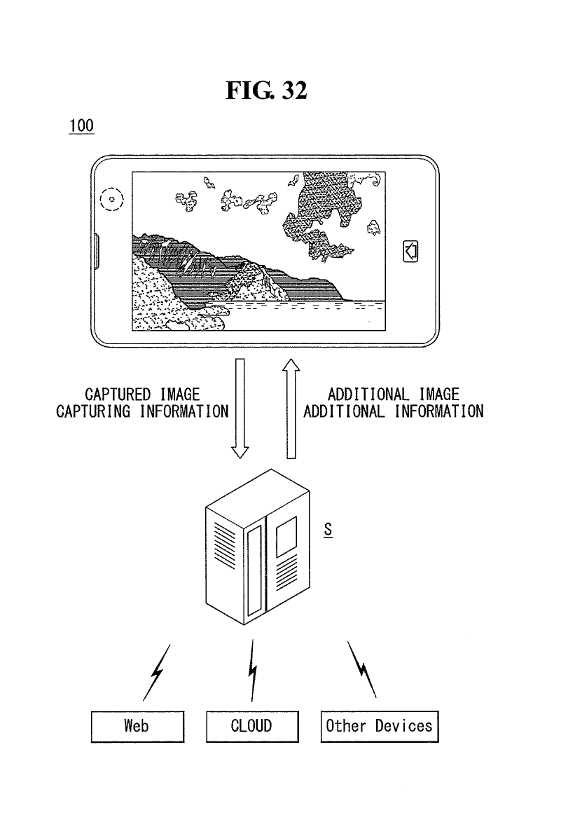

FIG. 32 illustrates information acquisition operation of the mobile terminal shown in FIG. 8. Referring to FIG. 32, the mobile terminal 100 according to an embodiment of the present invention can transmit or receive various types of data.

The mobile terminal 100 can transmit captured images and/or capturing information to the server S and the like. The server S can also transmit captured images and/or capturing information to a web, cloud service and/or other devices.

The server S may collect various types of data from a web, cloud service and/or other devices. The server S may transmit additional images and/or additional information, from among the collected data, to the mobile terminal 100. Upon reception of the additional images and/or additional information, the mobile terminal 100 may display the additional images and/or additional information on the display module 151.

The above-described method of controlling the mobile terminal may be written as computer programs and may be implemented in digital microprocessors that execute the programs using a computer readable recording medium. The method of controlling the mobile terminal may be executed through software. The software may include code segments that perform required tasks. Programs or code segments may also be stored in a processor readable medium or may be transmitted according to a computer data signal combined with a carrier through a transmission medium or communication network.

The computer readable recording medium may be any data storage device that can store data that can be thereafter read by a computer system. Examples of the computer readable recording medium may include read-only memory (ROM), random-access memory (RAM), CD-ROMs, DVD±ROM, DVD-RAM, magnetic tapes, floppy disks, optical data storage devices. The computer readable recording medium may also be distributed over network coupled computer systems so that the computer readable code is stored and executed in a distribution fashion.

A mobile terminal may include a first touch screen configured to display a first object, a second touch screen configured to display a second object, and a controller configured to receive a first touch input applied to the first object and to link the first object to a function corresponding to the second object when receiving a second touch input applied to the second object while the first touch input is maintained.

A method may be provided of controlling a mobile terminal that includes displaying a first object on the first touch screen, displaying a second object on the second touch screen, receiving a first touch input applied to the first object, and linking the first object to a function corresponding to the second object when a second touch input applied to the second object is received while the first touch input is maintained.

Any reference in this specification to “one embodiment,” “an embodiment,” “example embodiment,” etc., means that a particular feature, structure, or characteristic described in connection with the embodiment is included in at least one embodiment of the invention. The appearances of such phrases in various places in the specification are not necessarily all referring to the same embodiment. Further, when a particular feature, structure, or characteristic is described in connection with any embodiment, it is submitted that it is within the purview of one skilled in the art to effect such feature, structure, or characteristic in connection with other ones of the embodiments.

Although embodiments have been described with reference to a number of illustrative embodiments thereof, it should be understood that numerous other modifications and embodiments can be devised by those skilled in the art that will fall within the spirit and scope of the principles of this invention. More particularly, various variations and modifications are possible in the component parts and/or arrangements of the subject combination arrangement within the scope of the invention, the drawings and the appended claims. In addition to variations and modifications in the component parts and/or arrangements, alternative uses will also be apparent to those skilled in the art.

What is claimed is:

1. A mobile terminal, comprising:
a display;
a wireless communication unit configured to provide wireless communication;
a camera; and
a controller configured to:
capture an image via the camera,
store, in a memory, related capturing information related to the capturing of the image,
obtain, through the wireless communication unit, at least one surrounding image related to the captured image based on the related capturing information, and
display a synthesized image including the captured image and the obtained at least one surrounding image.

2. The mobile terminal of claim 1, wherein the related capturing information includes at least one of location information indication a location where the image was captured, capturing direction information indicating a capturing direction of the image, and view angle information indicating an angle of the camera when capturing the image.

3. The mobile terminal of claim 2, wherein the controller is further configured to:
obtain the related capturing information when the image is captured, and
store the obtained information along with the image in the memory.

4. The mobile terminal of claim 1, wherein the controller is further configured to discriminately display the image from the at least one surrounding image in the synthetic image.

5. The mobile terminal of claim 1, wherein the controller is further configured to generate a synthesized panorama image by combining the image and the at least one surrounding image in a landscape mode.

6. The mobile terminal of claim 1, wherein the controller is further configured to:
obtain additional images of places included in an area corresponding to the synthesized image, and
display the obtained additional images on the synthesized image so the obtained additional images respectively correspond to places where the additional images are captured.

7. The mobile terminal of claim 6, wherein the controller is further configured to display a selected additional image instead of the synthesized image on the display upon acquisition of a signal for selecting at least one of the additional images.

8. The mobile terminal of claim 1, wherein the controller is further configured to:
execute a gallery mode for displaying a plurality of images including the captured image,
upon acquisition of a signal for selecting at least one of the plurality of images, arrange images having a same attribute as capturing information of the selected at least one image, and
display the arranged images on the display.

9. The mobile terminal of claim 8, wherein the controller is further configured to:
display the plurality of images in the form of thumbnails on the display,
arrange the thumbnails in a landscape direction in order of time, and
vertically align thumbnails having a same attribute as a selected thumbnail with the selected thumbnail upon selection of one of the plurality of thumbnails.

10. The mobile terminal of claim 1, wherein the controller is further configured to resize the obtained at least one surrounding image to match a size of the captured image.

11. A method of controlling a mobile terminal, the method comprising:
capturing, via a camera of the mobile terminal, an image;
storing, in a memory, related capturing information related to the capturing of the image;
obtaining, via a controller controlling a wireless communication unit of the mobile terminal, at least one surrounding image related to the captured image based on the related capturing information; and
displaying, via a display unit of the mobile terminal, a synthesized image including the captured image and the obtained at least one surrounding image.

12. The method of claim 11, wherein the related capturing information includes at least one of location information indication a location where the image was captured, capturing direction information indicating a capturing direction of the image, and view angle information indicating an angle of the camera when capturing the image.

13. The method of claim 12, further comprising:
obtaining the related capturing information when the image is captured; and
storing the obtained information along with the image in the memory.

14. The method of claim 11, further comprising:
discriminately displaying the image from the at least one surrounding image in the synthetic image.

15. The method of claim 11, further comprising:
generating a synthesized panorama image by combining the image and the at least one surrounding image in a landscape mode.

16. The method of claim 11, further comprising:
obtaining additional images of places included in an area corresponding to the synthesized image; and
displaying the obtained additional images on the synthesized image so the obtained additional images respectively correspond to places where the additional images are captured.

17. The method of claim 16, further comprising:
displaying a selected additional image instead of the synthesized image on the display upon acquisition of a signal for selecting at least one of the additional images.

18. The method of claim 11, further comprising:
executing a gallery mode for displaying a plurality of images including the captured image;
upon acquisition of a signal for selecting at least one of the plurality of images, arranging images having a same attribute as capturing information of the selected at least one image; and
displaying the arranged images on the display.

19. The method of claim 18, further comprising:
displaying the plurality of images in the form of thumbnails on the display;
arranging the thumbnails in a landscape direction in order of time; and
vertically aligning thumbnails having a same attribute as a selected thumbnail with the selected thumbnail upon selection of one of the plurality of thumbnails.

20. The method of claim 11, further comprising:
resizing the obtained at least one surrounding image to match a size of the captured image.
